(19) United States
(12) Patent Application Publication
(10) Pub. No.: US 2021/0190930 A1
(43) Pub. Date: Jun. 24, 2021

(54) RANGING BETWEEN DEVICES

(71) Applicant: Nokia Technologies Oy, Espoo (FI)

(72) Inventors: Yonggang WANG, Shanghai (CN); Wei XIONG, Shanghai (CN)

(21) Appl. No.: 17/054,367

(22) PCT Filed: May 15, 2018
(86) PCT No.: PCT/CN2018/086881

§ 371 Date: Nov. 10, 2020

(51) Int. Cl. G01S 13/18; G01S 13/526; H04W 72/00

(52) U.S. Cl. CPC G01S 13/18; H04W 72/005; G01S 13/526

(57) ABSTRACT

Methods, devices and computer readable storage medium for ranging between a tag device (410) and plurality of anchor devices (405). The tag device (410) broadcasts a first poll message (605) to a plurality of anchor devices (405). The tag device (410) receives a plurality of response messages (620) for the first poll message (605) from the plurality of anchor devices (405). The plurality of response messages (620) are transmitted by the plurality of anchor devices (405) at a plurality of response time points. The plurality of response time points are associated with ranks of respective distances among a plurality of distances between the tag device (410) and the plurality of anchor devices (405). After receiving the plurality of response messages, the tag device (410) broadcasts a second poll message to the plurality of anchor devices (405). The ranging efficiency may be improved.

### FIELD

Embodiments of the present disclosure generally relate to the field of ranging, and in particular, to methods, devices and computer readable storage medium for ranging between a tag device and plurality of anchor devices.

### BACKGROUND

Single-sided two-way ranging (SS-TWR) and double-sided two-way ranging (DS-TWR) technologies have been widely used in indoor positioning. The SS-TWR technology is based on measurement of one round trip delay between two devices. For example, a device transmits a message to a further device and receives a response message from the further device. Then, the device may determine a round trip delay between the transmitted and received messages.

The DS-TWR ranging technology is an extension of the SS-TWR technology which is based on two round trip measurements. With this technology, the two measured round trip delays are combined to derive a time-of-flight estimate to reduce measurement errors even for quite long response delays.

A typical indoor positioning system based on the DS-TWR ranging technology may include a plurality of anchor devices and tag devices in Ultra-Wideband (UWB) wireless communications, for example. The time-of-flight estimates are measured between the anchor devices and the tag devices.

### SUMMARY

In general, example embodiments of the present disclosure provide methods, devices and computer readable storage medium for ranging between a tag device and plurality of anchor devices.

In a first aspect, a method at a tag device is provided. The tag device broadcasts a first poll message to a plurality of anchor devices. The tag device receives a plurality of response messages for the first poll message from the plurality of anchor devices. The plurality of response messages are transmitted by the plurality of anchor devices at a plurality of response time points. The plurality of response time points are associated with ranks of respective distances among a plurality of distances between the tag device and the plurality of anchor devices. After receiving the plurality of response messages, the tag device broadcasts a second poll message to the plurality of anchor devices.

In a second aspect, a method an anchor device of a plurality of anchor devices is provided. The anchor device receives a first poll message broadcast by a tag device. The anchor device transmits a response message for the first poll message to the tag device at a response time point. The response time point being associated with ranks of respective distances among a plurality of distances between the tag device and the plurality of anchor devices. Then, the anchor device receives a second poll message broadcast by the tag device.

In a third aspect, there is provided a device comprising at least one processor and at least one memory including computer program code. The at least one memory and the computer program code are configured to, with the at least one processor, cause the device to perform the method according to the first or second aspect.

In a fourth aspect, there is provided a computer readable storage medium that stores a computer program thereon. The computer program, when executed by a processor, causes the processor to perform the method according to the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a conventional process 100 of the SS-TWR round trip measurement;

FIG. 2 illustrates a conventional process 200 of the DS-TWR round trip measurement;

FIG. 3 illustrates a SS-TWR ranging process of a conventional positioning system;

FIG. 4 illustrates an example environment in which embodiments of the present disclosure may be implemented;

FIG. 5 illustrates an example arrangement of a positioning system according to some embodiments of the present disclosure;

FIG. 6 illustrates an example process of determining a response time point in accordance with some embodiments of the present disclosure;

FIG. 7 illustrates an example process of communications between the tag device and the anchor devices according to some embodiments of the present disclosure;

FIG. 8 illustrates a flowchart of an example method in accordance with some embodiments of the present disclosure;

FIG. 9 illustrates a flowchart of an example method in accordance with some other embodiments of the present disclosure;

FIG. 10 illustrates a simplified block diagram of a device that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “anchor device” refers to a device with a determined location in an environment. The anchor device may be fixed or movable in the environment. Examples of the anchor device include a base station (BS), a relay, an access point (AP), a node B (NodeB or NB), an evolved NodeB (eNodeB or eNB), a gigabit NodeB (gNB), a Remote Radio Module (RRU), a radio header (RH), a remote radio head (RRH), a low power node such as a femto, a pico, and the like. In some embodiments, a terminal device may serve as the anchor device. Examples of such a terminal device include a smart phone, a wireless-enabled tablet computer, laptop-embedded equipment (LEE), laptop-mounted equipment (LME), and/or wireless customer-premises equipment (CPE).

As used herein, the term “tag device” refers to a device to be positioned in the environment. The location of the tag device can be determined based on raging between the tag device and the anchor devices. Examples of the tag device include a smart phone, a wireless-enabled tablet computer, laptop-embedded equipment (LEE), laptop-mounted equipment (LME), and/or wireless customer-premises equipment (CPE).

As used herein, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

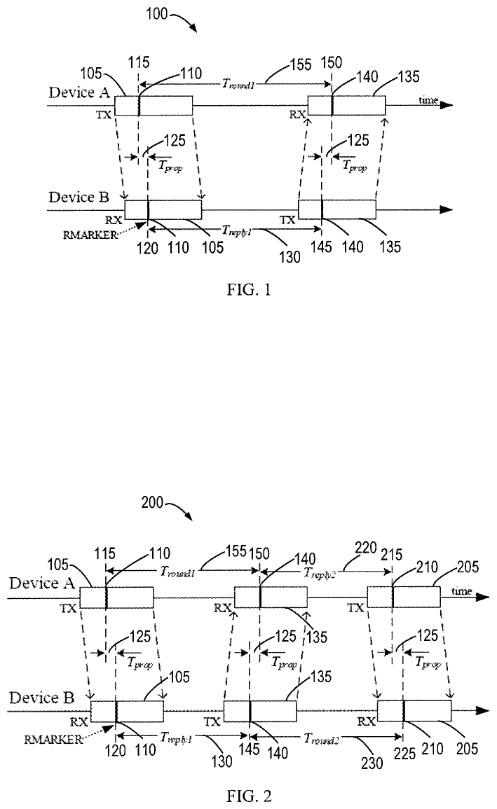

As described above, the SS-TWR ranging technology requires a signal round trip measurement between two nodes. FIG. 1 shows a conventional process 100 of the SS-TWR round trip measurement. As shown, a device A transmits a message 105 that contains a remarker 110 at a time point 115. The portion of the message 105 is data. The remarker 110 is used to indicate the starting of data in the message 105. Then, a device B detects the message 105 based on the remarker 110 at a time point 120 after a propagation time Tₚᵣₒₚ 125. After a reply period T_{reply1} 130, the device B transmits a further message 135 contains a remarker 140 at a time point 145. The device A detects the message 135 based on the remarker 140 at a time point 150 after the propagation time \hat{T}ₚᵣₒₚ 125. Then, a round trip delay T_{round1} 155 between the time points 115 and 150 is determined at the device A.

The DS-TWR ranging technology, as an extension of the SS-TWR technology, involves two round trip measurements. FIG. 2 shows a conventional process 200 of the DS-TWR round trip measurement. In the process 200, as shown, both the devices A and B measure the round trip delays. At the device A, the round trip delay T_{round1} 155 is measured, and meanwhile a message 205 containing a remarker 210 is transmitted as a response to the message 135 at a time point 215 after a time delay T_{reply2} 220. After detecting the message 205 based on the remarker 210 at time point 225, the device B measures the round trip time delay T_{round2} 230 between the time points 145 and 225.

In the process 200, each device precisely timestamps the transmission and reception time points of the messages. The resulting time-of-flight estimate, \hat{T}ₚᵣₑₚ, may be calculated using the following equation (1):

$${\hat{T}}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad ( 1 )$$

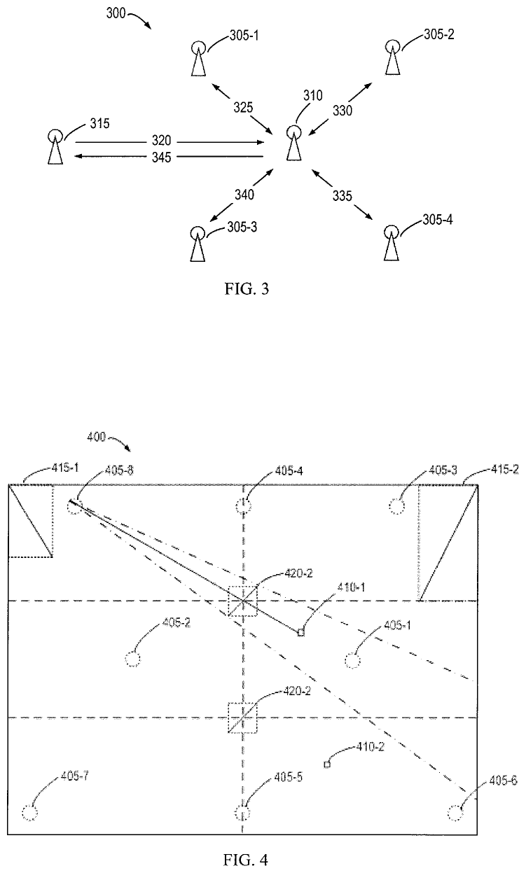

As described above, in an indoor positioning system based on the DS-TWR ranging technology, multiple measurements between the anchor devices and the tag devices are performed. FIG. 3 shows a SS-TWR ranging process of a conventional positioning system 300. As shown, in the system 300, locations of four anchor devices 305-1, 305-2, 305-3 and 305-4 (collectively referred to as an anchor device 305) are aware. A tag device 310 to be positioned may communicate with the anchor device 305, for example, with the UWB technology, to measure the respective round trip delays. In this example, after a gateway 315 sends (320) a measurement command to the tag device 310, the tag device 310 communicates (325, 330, 335, 340) with the four anchor devices 305-1, 305-2, 305-3 and 305-4, individually and subsequently.

Four distance measurements are performed. Typically, a single ranging communication may take almost 1 ms due to separated operations of a UWB transmitter and a UWB controller. Accordingly, a single measurement between the tag device 310 and the anchor device 305 takes almost 4 ms including a message propagation time of 3 ms and a message processing time of 1 ms. In this case, the four measurements may take 16 ms. Further, the tag device 310 sends (345) the measurement results to the gateway 315 for positioning of the tag device 310. The communications of the measurement command and results may take 2 ms. As a result, the whole measurement process takes 18 ms for positioning of one movement of the tag device 310.

In a spacious area, such as a hall, a lobby or a hallway, more anchor devices need to be deployed to enhance coverage in the area. The tag device 310 needs to reach more than 4 anchor devices 305 at any position in the area. If there are more than one tag devices in the area, a refresh rate of positioning, as a reciprocal of the positioning time, may be decreased dramatically due to sharing of time resources among the tags to fullfill the ranging and positioning operations, as shows in Table 1.

TABLE 1
The refresh rate of positioning in different cases

| | 3 anchor | 4 anchor | 5 anchor | 6 anchor |
|---|---|---|---|---|
| | devices | devices | devices | devices |
| 1 tag device | 71.43 Hz | 55.56 Hz | 45.45 Hz | 38.46 Hz |
| 10 tag devices | 7.14 Hz | 5.56 Hz | 4.55 Hz | 3.85 Hz |
| 50 tag devices | 1.43 Hz | 1.11 Hz | 0.91 Hz | 0.77 Hz |

As shown in Table 1, in the case of 50 tag devices and 6 anchor devices, the refresh rate of positioning is decreased to 0.77 Hz. The refresh rate of positioning limits the moving speed of the tag device. There is a need to reduce a time duration of the ranging process in a UWB indoor positioning system, especially for the large and seamless coverage. The conventional system cannot seamlessly cover more places including the hall, lobby, room, hallway and the like.

In addition, if more ranging operations are performed between the tag 310 and the anchor devices 305, the higher accuracy of positioning could be achieved. Thus, a refresh rate of positioning, as a reciprocal of the positioning time, will be increased due to much more measurements. For example, if one tag device ranges with three anchor devices using the DS-TWR technology, three distance measurements are required which involve 6 transmissions and three receptions to derive the location of the tag device. The conventional system cannot ensure a desired positioning refresh rate

Embodiments of the present disclosure provide a fast ranging scheme. With this scheme, a tag device broadcasts a poll message to a plurality of anchor devices. The tag device receives a plurality of response messages for the poll message from the anchor devices. Response time points of the response messages are associated with ranks of respective distances among a plurality of distances between the tag device and the anchor devices. Then, the tag device broadcasts a further poll message to the plurality of anchor devices.

Accordingly, at an anchor device, upon the reception of the poll message broadcast by the tag device, the anchor devices transmit response messages for the poll message individually at the determined response time points. The anchor devices then receive the further poll message broadcast by the tag device.

This fast ranging scheme may provide quick positioning and therefore may increase the refresh rate of positioning. Moreover, the fast ranging scheme may be applied in complex indoor places, such as the hall, lobby, and hallway to provide seamless positioning. Further, this scheme allows positioning of much more tag devices.

FIG. 4 illustrates an example environment 400 in which embodiments of the present disclosure may be implemented. The environment 400 is shown as a block which is illustrative but not limited. The environment 400 may be any suitable indoor or outdoor environment. A two-dimensional map of the environment 400 is shown in FIG. 4 only for the purpose of illustration. A three-dimensional map may also be used to represent a spatial structure of the environment 400.

As shown in FIG. 4, eight anchor devices 405-1, . . . , 405-8 (collectively referred to as an anchor device 405) are arranged in the environment 400. Two tag devices 410-1 and 410-2 (collectively referred to as a tag device 410) are moving in the environment 400. The movement position of the tag device 410 can be determined based on ranging between the tag device 410 and the anchor devices 405. It is to be understood that the arrangement of anchor devices and the numbers of anchor devices and tags are shown only for the purpose of illustration, without suggesting any limitation. Any suitable number of anchor devices may be arranged at any suitable locations in the environment 400 according to practical deployment, and there may be any suitable number of tag devices to be positioned in the environment 400.

The tag device 410 can wirelessly communicate with the anchor devices 405. The wireless communication may utilize any suitable wireless communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, machine type communication (MTC), and Ultra-Wideband (UWB) technologies. For the purpose of discussion, some embodiments are discussed in the scenario where the UWB technology is utilized.

In various embodiments of the present disclosure, the tag device 410 broadcasts a poll message (referred to as a first poll message) to a plurality of anchor devices 405. The anchor devices 405 for receiving the first poll message may be selected from a set of candidate anchor devices. For example, these anchor devices 405 may be selected from the anchor devices 405-1 to 405-8 which constitute the set of candidate anchor devices. The set of candidate anchor devices may also comprise other anchor devices not shown.

In some embodiments, the anchor devices 405 having non-line of sight (NLOS) channels with the tag device 410 may be excluded to further improve the ranging efficiency and the positioning accuracy. For example, as shown in FIG. 4, four obstacles exist in the environment 400, which include two meeting rooms 415-1 and 415-2 and two columns 420-1 and 420-2. When the tag device 410 is moving in the environment 400, the tag device 410 may be shadowed by these obstacles and therefore may communicate NLOS signals with the anchor devices 405-1 to 405-8. If these signals are used in the positioning, the positioning accuracy may be degraded. As a result, the anchor device 405 having a NLOS channel with the tag device 410 may excluded in the ranging with the tag device 410.

The anchor devices 405 with the NLOS channels may be determined based on map information of the environment 400 and a current location of the tag device 410. For example, using geometry algorithms, for example the radial algorithms as shown in FIG. 4, it can be determined that the anchor device 405-8 has a NLOS channel with the tag device 410. Then, the anchor device 405-8 is excluded, and the anchor devices 405-1 to 405-7 with line of sight (LOS) channels are reserved.

In order to further improve the ranging efficiency and the positioning accuracy, in some embodiments, the anchor device 405 for receiving the first poll message may be selected from the anchor devices 405-2 to 405-8 having the LOS channels based on the distances between the tag device 410 and these anchor devices. For example, the anchor devices 405 may be selected in an ascending order of the distances.

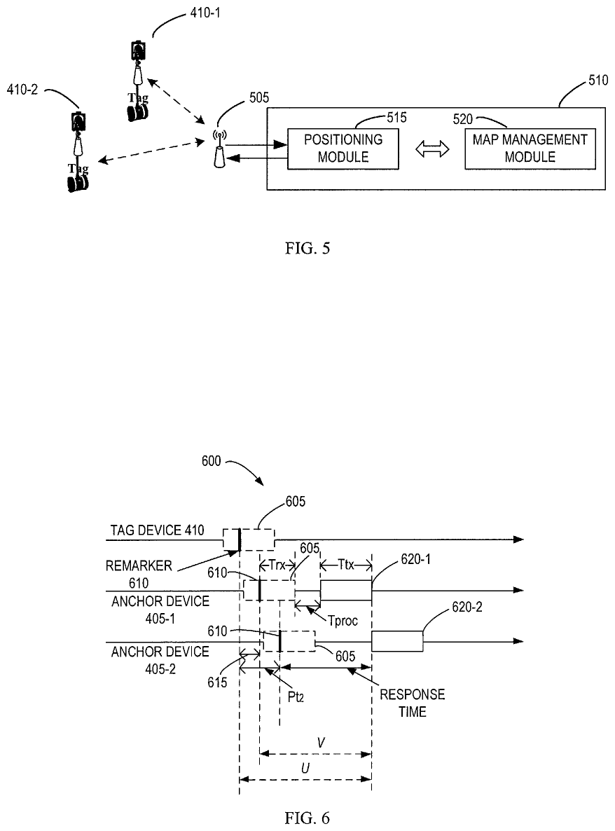

The distances may be determined in any suitable way. In some embodiments, the tag device 410 may determine the distances by the ranging with the anchor devices 405. An example process of determining the distances will be discussed below with reference to FIG. 5 which shows an example arrangement of a positioning system 500 according to some embodiments of the present disclosure.

In the system 500, a gateway 505 can communicate with the two tag devices 410-1 and 410-2 and a server 510. The server 510 includes a positioning module 515 for the positioning of the tag device 410. The server 510 also includes a map management module 520 for managing the map information of the environment 400. When the tag device 410 is powered on, the tag device 410 may automatically poll the surrounding anchor devices 405 and reports the distances with the anchor devices 405 to the server 510 via the gateway 505. Then, the server 510 calculates the location of the tag device 405 based on the reported distances.

In some embodiments, the server 510 may determine an ACTIVE anchor list based on the location of the tag device 410 and the map information of the environment 400. The ACTIVE anchor list includes the anchor devices with the LOS channels. The tag device 410 may download the ACTIVE anchor list as well as the distances of the respective anchor devices 405. Further, the tag device 410 may broadcast the first poll message to all or a part of the anchor devices 405 in the ACTIVE anchor list.

The ACTIVE anchor list may be updated as the tag device 410 is moving. When the tag device 110 is moving, the anchor devices with the NLOS channels may be excluded from the list, and the anchor devices currently having LOS channels with the tag device 410 may be reserved in the list.

In addition to obstruction of the anchor devices 405, the construction of the ACTIVE anchor list may consider the distances between the tag device 410 and the anchor devices 405. For example, the ACTIVE anchor list may include the anchor devices 405 with shorter distances with the tag device 410.

After receiving the first poll message broadcast by the tag device 410, the anchor devices 405 transmit response messages for the first poll message to the tag device 410. The response time points for the response messages are associated with ranks of respective distances among a plurality of distances between the tag device 410 and the anchor devices 405.

Each anchor device 405 may determine the response time point based on the ranks of the distances. The ranks may be determined by the anchor device 405 in any suitable way. In some embodiments, the anchor device 405 may obtain the ranks from the tag device 410. For example, the first poll message may include an indication (referred to as “a first indication”) for the ranks of the distances. In addition or alternatively, the anchor device 405 may obtain the ranks by communicating with a gateway or server (for example, the gateway 505 or the server 510 as shown in FIG. 5) or other devices in a wired or wireless way. In some other embodiments, the anchor devices 405 may obtain the distances of the anchor devices from the tag device 410 or other devices and then determine the ranks.

In some embodiments, the response time point may be determined by the anchor device 405 based on a rank difference of a reference rank and its own rank. In the case that the ranks are determined in an ascending order of the distances, if the rank of the anchor device 405 is higher than the reference rank, the anchor device 405 may determine that the response time point of the anchor device 405 may be later than a reference response time point associated with the reference rank. In this way, the response messages of different anchor devices 405 will arrive at the tag device 410 separately, and therefore the interferences of the response messages may be reduced.

The reference rank may be any suitable predefined value. In some embodiments, the reference rank may be assigned to 1, which corresponds to the anchor device 405 closest to the tag device 410 if the ranks are determined in an ascending order of the distances. In this case, the response time point of the anchor device 405 may be determined with respect to the response time point of the nearest anchor device 405.

In some embodiments, the anchor device 405 may determine a time difference of the response time point and a reference response time point associated with the reference rank. The time difference may be determined based on the rank difference. For example, the longer time difference may be set for the larger rank difference. In this way, the response messages from different anchor devices may arrive 405 at the tag device 410 subsequently and separately, and therefore both the ranging efficiency and the positioning accuracy may be improved. In some embodiments, the time difference may be determined by the tag device 410 or other devices and sent to the anchor device 405.

In order to further improve the ranging efficiency, the time difference may be determined further based on a reference propagation time of the first poll message associated with the reference rank. The reference propagation time may be determined by the anchor device 405 based on the distance associated with the reference rank.

As an alternative example, the reference propagation time may be obtained by the anchor device 405 from the tag device 410. For example, the first poll message may include a second indication for the reference propagation time. Then, the anchor device 405 may determine the time difference based on the rank difference, the reference propagation time and a propagation time of the first poll message to itself.

An example process of determining the response time point will be discussed below with reference to FIG. 6. In the process 600 as shown in FIG. 6, the tag device 410 broadcasts the first poll message 605 containing a remarker 610 to the anchor devices 405-1 and 405-2. In this example, the rank “1” for the nearest anchor device 405-1 is defined as the reference rank. Then, the propagation time 615 of the first poll message 605 from the tag device 410 to the anchor device 405-1 acts as the reference propagation time.

In this case, the response time point of the anchor device 405-2 may be determined using the following equation (2):

(Response time)ₙ=Tᵣₓ+T_{proc}+Tₜₓ*(n−1)+Pt₁−Ptₙ (2)

where (Response time)ₙ represents a response time of the anchor device 405 with the rank n, which indicates a time duration from the reception of the first poll message and the transmission of the response time; Tᵣₓ represents a receiving time of the first poll message; Tₜₓ represents a transmitting time of the response message; T_{proc} represents a processing time with the anchor device; Pt₁ represents the reference propagation time for the reference rank 1; and Ptₙ represents a propagation time of the anchor device 405 with the rank n. Tᵣₓ and Tᵣₓ depend on a message length and a transmission data rate.

The equation (2) is derived from the following equations (3)-(5):

(Response time)ₙ=U−Ptₙ (3)

U=V+Pt₁ (4)

V=Tᵣₓ+T_{proc}+Tₜₓ*(n−1) (5)

With the equation (2), the successive response messages are transmitted one by one. No interference occurs, and the time duration of the ranging process may be reduced.

In the example as shown in FIG. 6, the rank of the anchor device 405-2 is 2. Then, the response time of the anchor device 405-2 is Tᵣₓ+T_{proc}+Tₜₓ+Pt₁−Pt₂. As shown in FIG. 6, upon the transmission of a response message 620-1 from the anchor device 405-5, the anchor device 405-6 immediately transmits a response message 620-2. It is possible that the two subsequent response messages are separated by a predetermined gap to further avoid the interferences of the response messages.

The response time points of the anchor devices 405 may also be determined by the tag device 410 or other devices and sent to the respective anchor devices. The operations and processes are similar to those of the anchor devices 405 as described above, and the details thereof will be omitted.

Upon the receptions of the response messages from all the anchor devices 405, the tag device 410 may broadcast a further poll message (referred to as “a second poll message”) to the anchor devices 405. Based on the transmission and reception time points of these messages, the tag device 410 and the anchor device 405 may all measure the round trip delays. The communications of the poll message and the response message may be performed between the tag device 410 and the anchor devices 405 for many rounds.

In some embodiments, the ranging process may involve only two round trip measurements. In this case, the second poll message may be considered as a final message to terminate the ranging process.

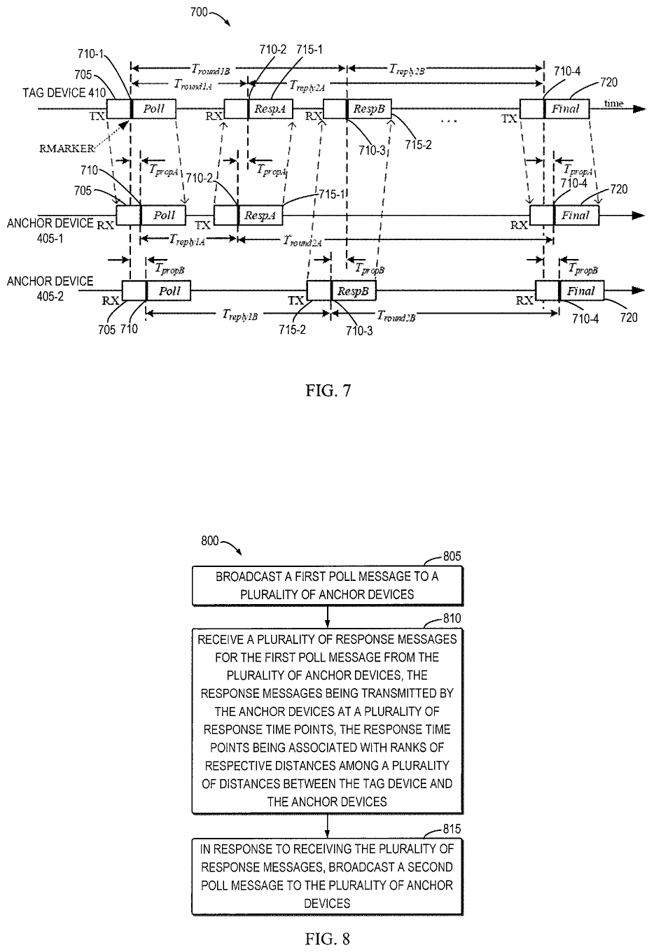

FIG. 7 shows an example process 700 of communications between the tag device 410 and the anchor devices 405 according to some embodiments of the present disclosure.

As shown in FIG. 7, the tag device 410 broadcasts a poll message 705 (as the first poll message) containing a remarker 710-1. The anchor devices 405-1 and 405-2 transmit response messages 715-1 and 715-2 containing remarkers 710-2 and 710-3, respectively. Other anchor devices 405 receiving the poll message 705 will also transmit the response messages. In the process 700, two round trip measurements are required. After the tag device 405 receives the response messages from all the anchor devices, the tag device 405 broadcasts a final message 720 containing a remarker 710-4. Then, the tag device 410 and the anchor devices 405-1 and 405-2 may measure the round trip delays.

With the fast ranging scheme according to embodiments of the present disclosure, the required time may be significantly reduced. As described above, if a single ranging communication requires almost 1 ms, the measurements between the tag device 410 and three anchor devices 405 requires almost 5 ms. If the tag device 410 and the anchor devices 405 wirelessly communicate, for example via the UWB, it needs additional 3 ms to report the measurement results. By adding the communication time between the gateway (for example, the gateway 505 in FIG. 5) and the tag device 410 and the processing time within the devices, totally about 10 ms is required to take one positioning movement in the fast ranging scheme. If the anchor devices have wired connections to the gateway, for example via the Ethernet, only 7 ms is required to take one positioning movement in the fast ranging scheme.

Table 2 and Table 3 show the refresh rates in the cases that the anchor devices are connected via the UWM and the Ethernet, respectively.

TABLE 2
The refresh rate of positioning (anchor connected by UWB)

| | 3 anchor | 4 anchor | 5 anchor | 6 anchor |
|---|---|---|---|---|
| | devices | devices | devices | devices |
| 1 tag device | 100 Hz | 83.33 Hz | 71.43 Hz | 62.5 Hz |
| 10 tag devices | 10 Hz | 8.33 Hz | 7.14 Hz | 6.25 Hz |
| 50 tag devices | 2 Hz | 1.67 Hz | 1.43 Hz | 1.25 Hz |

TABLE 2
The refresh rate of positioning (anchor connected by Ethernet)

| | 3 anchor | 4 anchor | 5 anchor | 6 anchor |
|---|---|---|---|---|
| | devices | devices | devices | devices |
| 1 tag device | 142.86 Hz | 111.11 Hz | 90.91 Hz | 76.92 Hz |
| 10 tag devices | 14.29 Hz | 11.11 Hz | 9.09 Hz | 7.69 Hz |
| 50 tag devices | 2.86 Hz | 2.22 Hz | 1.82 Hz | 1.54 Hz |

Compared with the refresh rates of positioning as shown in Table 1, the fasting ranging scheme increases the refresh rates of positioning, significantly.

FIG. 8 shows a flowchart of an example method 800 in accordance with some embodiments of the present disclosure. The method 800 can be implemented at the tag device 410 as shown in FIG. 4. For the purpose of discussion, the method 400 will be described with reference to FIG. 4.

At block 805, the tag device 410 broadcasts a first poll message to a plurality of anchor devices 405. At block 810, the tag device 410 receives a plurality of response messages for the first poll message from the plurality of anchor devices 405. The plurality of response messages being transmitted by the plurality of anchor devices 405 at a plurality of response time points. The plurality of response time points are associated with ranks of respective distances among a plurality of distances between the tag device 410 and the plurality of anchor devices 405. At block 815, in response to receiving the plurality of response messages, the tag device 410 broadcasts a second poll message to the plurality of anchor devices.

In some embodiments, the tag device 410 may determine the ranks of the respective distances among the plurality of distances. The tag device 410 may then broadcast, to the plurality of anchor devices 405 at the transmitting time point, the poll message comprising a first indication for the ranks of the respective distances. In some embodiments, the poll message may comprise a second indication for a reference propagation time of the first poll message associated with a reference rank.

In some embodiments, the tag device 410 may select, from a set of candidate anchor devices, the plurality of anchor devices 405 having line of sight channels with the tag device 410.

In some embodiments, the tag device 410 may determine, among the set of candidate anchor devices, a plurality of candidate anchor devices with line of sight channels to the tag device 410. Then, the tag device 410 may select the plurality of anchor devices 405 from the plurality of candidate anchor devices in an ascending order of distances between the target device 410 and the plurality of candidate anchor devices.

FIG. 9 shows a flowchart of an example method 900 in accordance with some embodiments of the present disclosure. The method 900 can be implemented at the anchor device 405 as shown in FIG. 4. For the purpose of discussion, the method 900 will be described with reference to FIG. 4.

At block 905, the anchor device 405 receives a first poll message broadcast by the tag device 410. At block 910, the anchor device 405 transmits a response message for the first poll message to the tag device 410 at a response time point. The response time point is associated with ranks of respective distances among a plurality of distances between the tag device and the plurality of anchor devices. At block 915, the anchor device 405 receives a second poll message broadcast by the tag device 410.

In some embodiments, the anchor device 405 may determine a rank difference of a reference rank and a rank of a distance between the tag device and the anchor device among the plurality of distances. Then, the anchor device 410 may determine the response time point at least in part based on the rank difference.

In some embodiments, the first poll message may comprise a first indication for the ranks of the respective distances among the plurality of distances. The anchor device 405 may determine the rank difference based on the ranks of the respective distances among the plurality of distances.

In some embodiments, the anchor device 405 may determine a time difference of the response time point and a reference response time point associated with the reference rank at least in part based on the rank difference.

In some embodiments, the first poll message comprises a second indication for a reference propagation time of the first poll message associated with the reference rank. The anchor device 405 may determine the time difference based on the rank difference, the reference propagation time and a propagation time of the first poll message from the tag device 410 to the anchor device 405.

It is to be understood that all operations and features related to the tag device 410 and the anchor device 405 described above with reference to FIGS. 4-7 are likewise applicable to the methods 800 and 900 and have similar effects. For the purpose of simplification, the details will be omitted.

In some embodiments, an apparatus capable of performing the method 800 (for example, the tag device 410) or the method 900 (for example, the anchor device 405) may comprise means for performing the respective steps of the method 800 or 900. The means may be implemented in any suitable form. For example, the means may be implemented in a circuitry or software module.

In some embodiments, the apparatus capable of performing the method 800 comprises: means for broadcasting, at a tag device, a first poll message to a plurality of anchor devices; means for receiving a plurality of response messages for the first poll message from the plurality of anchor devices, the plurality of response messages being transmitted by the plurality of anchor devices at a plurality of response time points, the plurality of response time points being associated with ranks of respective distances among a plurality of distances between the tag device and the plurality of anchor devices; and means for in response to receiving the plurality of response messages, broadcasting a second poll message to the plurality of anchor devices.

In some embodiments, the means for broadcasting the first poll message comprises: means for determining the ranks of the respective distances among the plurality of distances; and means for broadcasting, to the plurality of anchor devices at the transmitting time point, the poll message comprising a first indication for the ranks of the respective distances.

In some embodiments, the poll message comprises a second indication for a reference propagation time of the first poll message associated with a reference rank.

In some embodiments, the apparatus may comprise means for selecting, from a set of candidate anchor devices, the plurality of anchor devices having line of sight channels with the tag device.

In some embodiments, the means for selecting the plurality of anchor devices comprises: means for determining, among the set of candidate anchor devices, a plurality of candidate anchor devices with line of sight channels to the tag device; and means for selecting the plurality of anchor devices from the plurality of candidate anchor devices in an ascending order of distances between the target device and the plurality of candidate anchor devices.

In some embodiments, the apparatus capable of performing the method 900 comprises: means for receiving, at an anchor device of a plurality of anchor devices, a first poll message broadcast by a tag device; means for transmitting a response message for the first poll message to the tag device at a response time point, the response time point being associated with ranks of respective distances among a plurality of distances between the tag device and the plurality of anchor devices; and means for receiving a second poll message broadcast by the tag device.

In some embodiments, the apparatus may further comprise: means for determining a rank difference of a reference rank and a rank of a distance between the tag device and the anchor device among the plurality of distances; and means for determining the response time point at least in part based on the rank difference.

In some embodiments, the first poll message may comprise a first indication for the ranks of the respective distances among the plurality of distances. The means for determining the rank difference may comprise: means for determining the rank difference based on the ranks of the respective distances among the plurality of distances.

In some embodiments, the means for determining the response time point at least in part based on the rank difference may comprise: means for determining a time difference of the response time point and a reference response time point associated with the reference rank at least in part based on the rank difference.

In some embodiments, the first poll message may comprise a second indication for a reference propagation time of the first poll message associated with the reference rank. The means for determining the time difference may comprise: means for determining the time difference based on the rank difference, the reference propagation time and a propagation time of the first poll message from the tag device to the anchor device.

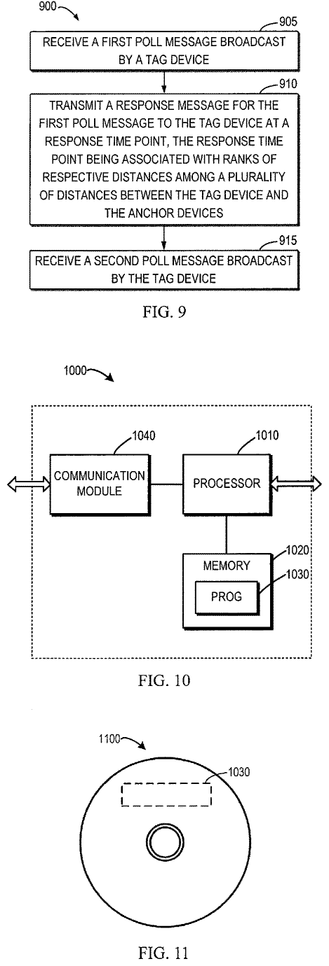

FIG. 10 is a simplified block diagram of a device 1000 that is suitable for implementing embodiments of the present disclosure. The device 1000 can be implemented at or as at least a part of the tag device 410 or a part of the anchor device 405 as shown in FIG. 4.

As shown, the device 1000 includes a processor 1010, a memory 1020 coupled to the processor 1010, a communication module 1040 coupled to the processor 1010, and a communication interface (not shown) coupled to the communication module 1040. The memory 1020 stores at least a program 1030. The communication module 1040 is for bidirectional communications. The communication interface may represent any interface that is necessary for communication.

The program 1030 is assumed to include program instructions that, when executed by the associated processor 1010, enable the device 1000 to operate in accordance with the embodiments of the present disclosure, as discussed herein with reference to FIGS. 4-9. The embodiments herein may be implemented by computer software executable by the processor 1010 of the device 1000, or by hardware, or by a combination of software and hardware. The processor 1010 may be configured to implement various embodiments of the present disclosure.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the memory 1020 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium 1100 may have the program 1030 stored thereon.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

When the device 1000 acts as the tag device 410, the processor 1010 and the memory 1020 may cooperate to cause the device 1000 to implement the method 800 as discussed herein with reference to FIG. 8. When the device 1000 acts as the anchor device 405, the processor 1010 and the memory 1020 may cooperate to cause the device 1000 to implement the method 900 as discussed herein with reference to FIG. 9.

All operations and features related to the tag device 410 and the anchor device 405 described above with reference to FIGS. 4-9 are likewise applicable to the device 1000 and have similar effects. For the purpose of simplification, the details will be omitted.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 800 and 900 as described above with reference to FIGS. 8 and 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various embodiments of the techniques have been described. In addition to or as an alternative to the above, the following examples are described. The features described in any of the following examples may be utilized with any of the other examples described herein.

1-22. (canceled)

23. A method comprising:
broadcasting, at a tag device, a first poll message to a plurality of anchor devices;
receiving a plurality of response messages for the first poll message from the plurality of anchor devices, the plurality of response messages being transmitted by the plurality of anchor devices at a plurality of response time points, the plurality of response time points being associated with ranks of respective distances among a plurality of distances between the tag device and the plurality of anchor devices; and
in response to receiving the plurality of response messages, broadcasting a second poll message to the plurality of anchor devices.

24. The method of claim 23, wherein broadcasting the first poll message comprises:
determining the ranks of the respective distances among the plurality of distances; and
broadcasting, to the plurality of anchor devices at the transmitting time point, the poll message comprising a first indication for the ranks of the respective distances.

25. The method of claim 23, wherein the poll message comprises a second indication for a reference propagation time of the first poll message associated with a reference rank.

26. The method of claim 23, further comprising:
selecting, from a set of candidate anchor devices, the plurality of anchor devices having line of sight channels with the tag device.

27. The method of claim 26, wherein selecting the plurality of anchor devices comprises:
determining, among the set of candidate anchor devices, a plurality of candidate anchor devices with line of sight channels to the tag device; and
selecting the plurality of anchor devices from the plurality of candidate anchor devices in an ascending order of distances between the target device and the plurality of candidate anchor devices.

28. A device, comprising:
at least one processor; and
at least one memory including computer program code;
the at least one memory and the computer program code configured to, with the at least one processor, cause the device to:
broadcast, at a tag device, a first poll message to a plurality of anchor devices;
receive a plurality of response messages for the first poll message from the plurality of anchor devices, the plurality of response messages being transmitted by the plurality of anchor devices at a plurality of response time points, the plurality of response time points being associated with ranks of respective distances among a plurality of distances between the tag device and the plurality of anchor devices; and
in response to receiving the plurality of response messages, broadcast a second poll message to the plurality of anchor devices.

29. The device of claim 28, wherein the at least one memory and the computer program code are configured to, with the at least one processor, cause the device to:
determine the ranks of the respective distances among the plurality of distances; and
broadcast, to the plurality of anchor devices at the transmitting time point, the first poll message comprising a first indication for the ranks of the respective distances.

30. The device of claim 28, wherein the first poll message comprises a second indication for a reference propagation time of the first poll message associated with a reference rank.

31. The device of claim 28, wherein the at least one memory and the computer program code are further configured to, with the at least one processor, cause the device to:
select, from a set of candidate anchor devices, the plurality of anchor devices having line of sight channels with the tag device.

32. The device of claim 31, wherein the at least one memory and the computer program code are configured to, with the at least one processor, cause the device to:
determine, among the set of candidate anchor devices, a plurality of candidate anchor devices with line of sight channels to the tag device; and
select the plurality of anchor devices from the plurality of candidate anchor devices in an ascending order of distances between the target device and the plurality of candidate anchor devices.

33. The device of claim 28, wherein the device is a smart phone, a wireless-enabled tablet computer, laptop-embedded equipment, laptop-mounted equipment, and/or wireless customer-premises equipment.

34. A device comprising:
at least one processor; and
at least one memory including computer program code;
the at least one memory and the computer program code configured to, with the at least one processor, cause the device to:
receive, at an anchor device of a plurality of anchor devices, a first poll message broadcast by a tag device;
transmit a response message for the first poll message to the tag device at a response time point, the response time point being associated with ranks of respective distances among a plurality of distances between the tag device and the plurality of anchor devices; and
receive a second poll message broadcast by the tag device.

35. The device of claim 34, the at least one memory and the computer program code are further configured to, with the at least one processor, cause the device to:
determine a rank difference of a reference rank and a rank of a distance between the tag device and the anchor device among the plurality of distances; and
determine the response time point at least in part based on the rank difference.

36. The device of claim 35, wherein the first poll message comprises a first indication for the ranks of the respective distances among the plurality of distances, and
wherein the at least one memory and the computer program code are configured to, with the at least one processor, cause the device to determine the rank difference based on the ranks of the respective distances among the plurality of distances.

37. The device of claim 35, the at least one memory and the computer program code are configured to, with the at least one processor, cause the device to:
determine a time difference of the response time point and a reference response time point associated with the reference rank at least in part based on the rank difference.

38. The device of claim 37, wherein the first poll message comprises a second indication for a reference propagation time of the first poll message associated with the reference rank, and
wherein the at least one memory and the computer program code are configured to, with the at least one processor, cause the device to determine the time difference based on the rank difference, the reference propagation time and a propagation time of the first poll message from the tag device to the anchor device.

39. The device of claim 34, wherein the device is a base station, a relay, an access point, a node B, an evolved NodeB, a gigabit NodeB, a Remote Radio Module, a radio header, a remote radio head, a low power node, a smart phone, a wireless-enabled tablet computer, laptop-embedded equipment, laptop-mounted equipment, and/or wireless customer-premises equipment.
